(19) United States
(12) Patent Application Publication
(10) Pub. No.: US 2013/0342799 A1
(43) Pub. Date: Dec. 26, 2013

(54) DRIVEN ELECTRODE STRUCTURE OF IN-PLANE SWITCHING LIQUID CRYSTAL DISPLAY

(71) Applicant: HANNSTAR DISPLAY CORP., New Taipei City (TW)

(72) Inventors: CHENG-JUI HUANG, Taoyuan County (TW); RONG-BING WU, Kaohsiung City (TW); CHIEN-HAO WU, Tainan City (TW); PO-HSIAO CHEN, Yunlin County (TW)

(73) Assignee: HANNSTAR DISPLAY CORP., New Taipei City (TW)

(21) Appl. No.: 13/847,263

(22) Filed: Mar. 19, 2013

(30) Foreign Application Priority Data
Jun. 25, 2012 (CN) 201210213737.2

(51) Int. Cl. G02F 1/1343

(52) U.S. Cl. CPC G02F 1/13439
USPC 349/139

(57) ABSTRACT

A driven electrode structure of an in-plane switching liquid crystal display is divided into a plurality of sub-regions, each of the sub-regions includes a plurality of sub-driven electrodes, a plurality of intervals is formed between adjacent sub-driven electrodes, so as each of the sub-regions has the intervals, and at least two of the intervals in the sub-regions are different from one another. By changing the width or shape of each sub-driven electrode, at least two of the intervals in the sub-regions are different from one another, so as the Mura condition of the in-plane switching liquid crystal display can be obscure, so as the Mura defect can be minimized uniformly without being visually recognized by human eyes and further improve the visual defect of the Mura.

### CROSS-REFERENCE TO RELATED APPLICATIONS

This application claims priority to and the benefit of Chinese Patent Application Number 201210213737.2, filed in the State Intellectual Property Office (SIPO) of China on Jun. 25, 2012, the entire content of which is incorporated herein by reference.

### FIELD OF THE INVENTION

The present invention relates to a driven electrode structure of an in-plane switching liquid crystal display, in particular to the driven electrode structure of an in-plane switching liquid crystal display capable of fuzzifying Muras of the in-plane switching liquid crystal display effectively.

### BACKGROUND OF THE INVENTION

In a liquid crystal display, current is passed through a transistor to produce a change of electric field, so as to cause an orientation of liquid crystal molecules, and then a polarizer is used to determine the bright/dark condition of pixels. Since an upper glass is attached to a color filter to form pixels of red, blue and green colors, the pixels with red, blue and green colors constitute an image screen on a display panel.

With reference to FIG. 1 for a schematic view of a conventional driven electrode structure of an in-plane switching (IPS) liquid crystal display, the conventional driven electrode structure of an in-plane switching liquid crystal display is divided into a plurality of sub-regions per unit pixel. Each sub-region includes a plurality of sub-driven electrodes. A constant interval d is between two adjacent sub-driven electrodes. The width W and the shape are the same for each sub-driven electrode.

However, since the constant interval between two adjacent sub-driven electrodes is maintained constant in the manufacturing process, if the width W of each sub-driven electrode has a slight error, the Mura defect of the in-plane switching liquid crystal display will be caused. The foregoing problems are technical issues to be solved.

### SUMMARY OF THE INVENTION

In view of the aforementioned problems of the prior art, the inventor of the present invention based on years of experience in the related industry to conduct extensive researches and experiments and finally developed a driven electrode structure of an in-plane switching liquid crystal display to overcome the drawbacks of the prior art.

Therefore, it is a primary objective of the present invention to provide a driven electrode structure of an in-plane switching liquid crystal display that changes the width or shape of each of the sub-driven electrodes, so as at least two of the intervals of the sub-regions are different from one another.

Another objective of the present invention is to provide a driven electrode structure of an in-plane switching liquid crystal display capable of fuzzifying a Mura condition of the in-plane switching liquid crystal display effectively.

A further objective of the present invention is to provide a driven electrode structure of an in-plane switching liquid crystal display capable of uniformly minimizing the Mura defect without being recognized visually by human eyes, so as to further improve the visual defect of the Mura.

To achieve the aforementioned objective, the present invention provides a driven electrode structure of an in-plane switching liquid crystal display, and the driven electrode structure is divided into a plurality of sub-regions, each sub-region includes a plurality of sub-driven electrodes, wherein a plurality of intervals is formed between adjacent sub-driven electrodes, so as each of the sub-region has the intervals. Among the intervals of the sub-regions, at least two intervals are different from one another. In the driven electrode structure of an in-plane switching liquid crystal display of the present invention, the width or the shape of each of the sub-driven electrodes are changed, such that at least two of the intervals of the sub-regions are different from one another. With this design, the Mura condition of the in-plane switching liquid crystal display can be obscure effectively and the Mura can be minimized uniformly without being visually recognized by human eyes, so as to further improve the visual defect caused by the Mura.

### BRIEF DESCRIPTION OF THE DRAWINGS

FIG. 1 is a schematic view of a conventional driven electrode structure of an in-plane switching liquid crystal display;

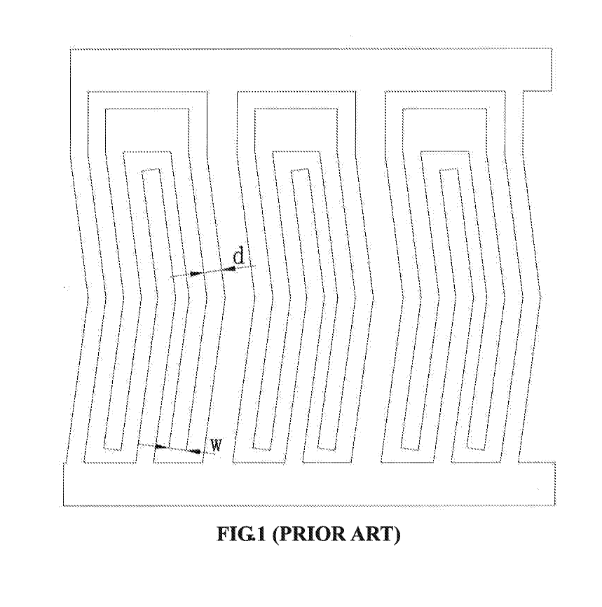

FIG. 2 is a schematic view of a driven electrode structure of an in-plane switching liquid crystal display in accordance with a first preferred embodiment of the present invention;

FIG. 3 is a schematic view of a driven electrode structure of an in-plane switching liquid crystal display in accordance with a second preferred embodiment of the present invention;

FIG. 4 is a schematic view of a driven electrode structure of an in-plane switching liquid crystal display in accordance with a third preferred embodiment of the present invention; and

FIG. 5 is a schematic view of a driven electrode structure of an in-plane switching liquid crystal display in accordance with a fourth preferred embodiment of the present invention.

### DESCRIPTION OF THE PREFERRED EMBODIMENTS

The technical characteristics of the present invention will be apparent with the detailed description of the preferred embodiments accompanied with the illustration of related drawings as follows. It is noteworthy that same numerals represent same respective elements.

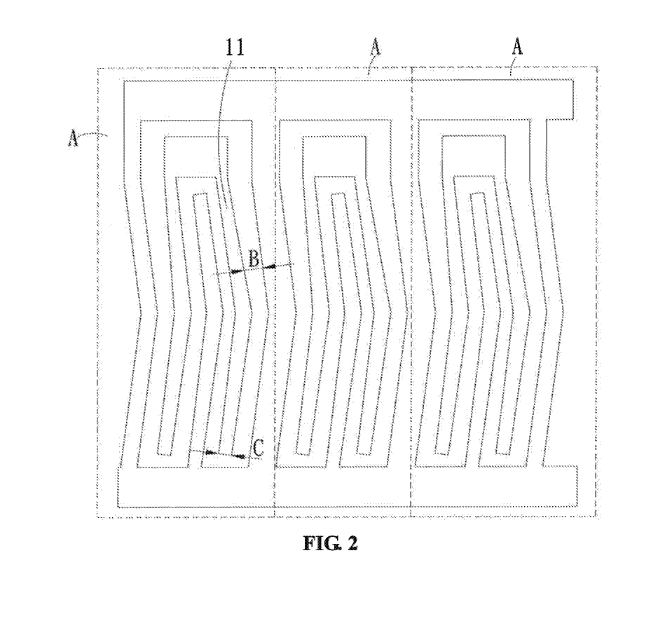

With reference to FIG. 2 for a schematic view of a driven electrode structure of an in-plane switching liquid crystal display in accordance with the first preferred embodiment of the present invention, the driven electrode structure of the in-plane switching liquid crystal display is divided into a plurality of sub-regions A. Each of the sub-regions A comprises a plurality of sub-driven electrodes 11. A plurality of intervals B is formed between adjacent sub-driven electrodes 11, so as each of the sub-regions A has the intervals B. In the intervals B of the sub-regions A, at least two intervals B are different from one another. In this preferred embodiment, the width C of each of the sub-driven electrode 11 decreases in a longitudinal direction from the center to both sides of the sub-driven electrode 11. With the taper design of the width C of each sub-driven electrode 11, at least two of the intervals B in the sub-regions A are different from one another. Each of the sub-driven electrodes 11 is a transparent electrode or a metal electrode. Each of the sub-driven electrodes 11 is made of a transparent conductive film or metal. In other words, the difference of at least two intervals B falls within a range of 0.2 μm˜20 μm. Each of the sub-driven electrodes 11 can be disposed on the same layer or different layers.

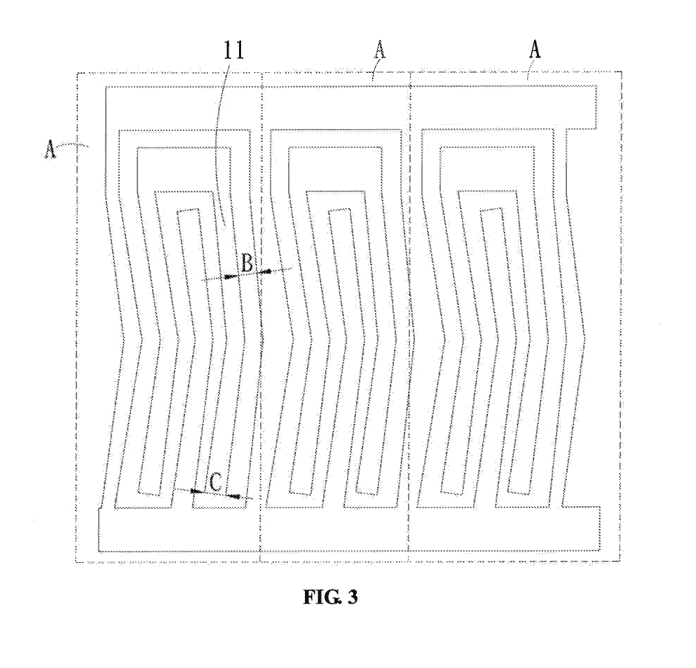

With reference to FIG. 3 for a schematic view of a driven electrode structure of an in-plane switching liquid crystal display in accordance with the second preferred embodiment of the present invention, the difference between this preference and the first preferred embodiment resides on that the width C of each of the sub-driven electrodes 11 of this preferred embodiment increases in a longitudinal direction from the center to both sides of the sub-driven electrode 11. With the gradual increasing design of the width C of each sub-driven electrode 11, at least two of the intervals B in the sub-regions A are different from one another. In other words, the difference between at least intervals B falls within a range of 0.2 μm˜20 μm.

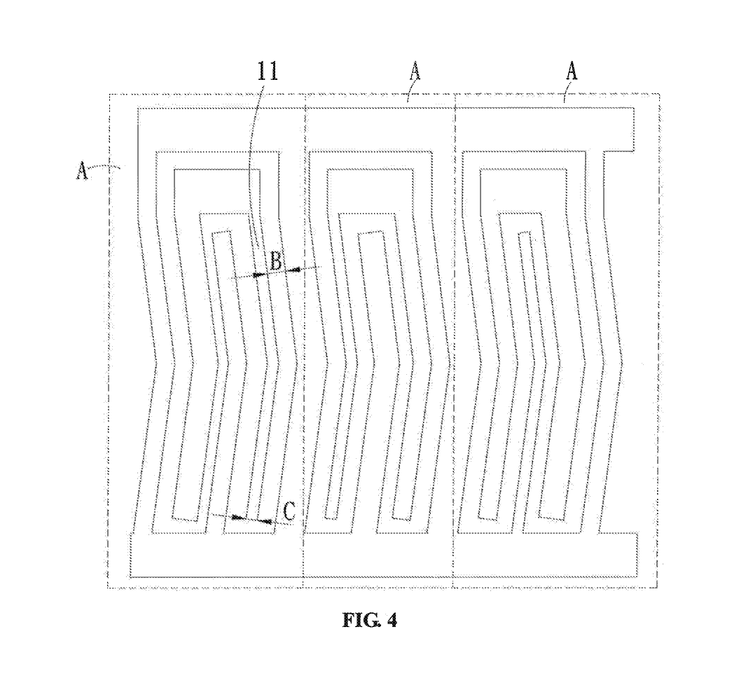

With reference to FIG. 4 for a schematic view of a driven electrode structure of an in-plane switching liquid crystal display in accordance with the third preferred embodiment of the present invention, the difference between this preference and the first or second preferred embodiment resides on that the width C of adjacent sub-driven electrodes 11 are different from one another, so as at least two of the intervals B in the sub-regions A are different from one another. In other words, the difference between at least two intervals B falls within a range of 0.2 μm˜20 μm.

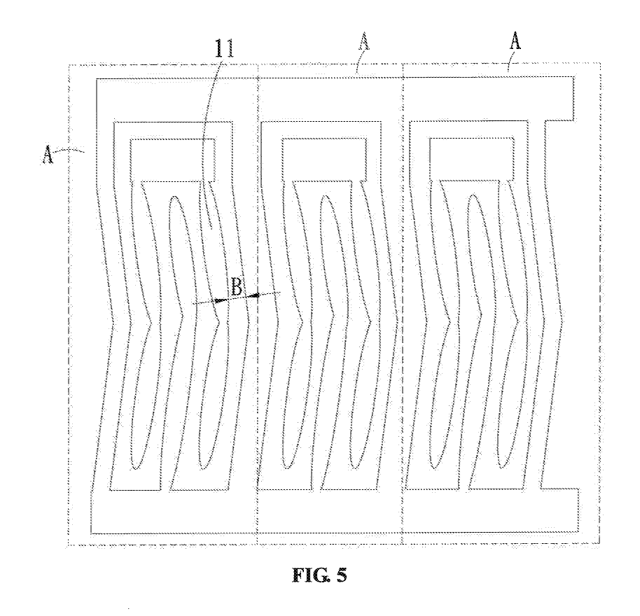

With reference to FIG. 5 for a schematic view of a driven electrode structure of an in-plane switching liquid crystal display in accordance with the fourth preferred embodiment of the present invention, the driven electrode structure of an in-plane switching liquid crystal display is divided into a plurality of sub-regions A. Each sub-region A comprises a plurality of sub-driven electrodes 11. A plurality of intervals B is formed between adjacent sub-driven electrodes 11, so as each of the sub-regions A has the intervals B, and at least two of the intervals B in the sub-regions A are different from one another. In this preferred embodiment, each of the sub-driven electrodes 11 is composed of two non-square structures connected to each other. The non-square structure is a long elliptical structure, a circular arc structure or an irregular-shaped structure, for example. With this design, at least two of the intervals B in the sub-regions A are different from one another. In other words, the difference between at least two of the intervals B falls within a range of 0.2 μm˜20 μm. Each of the sub-driven electrodes 11 can be disposed on the same layer or different layers.

It is noteworthy that the in-plane switching liquid crystal display further comprises an upper substrate, a lower substrate, a liquid crystal layer, a gate line or a data line besides the driven electrode structure, these elements are not the key points of the present invention and are well known to those ordinarily skilled in the art, thus these elements will not be described in details.

To sum up, the driven electrode structure of an in-plane switching liquid crystal display in accordance with the present invention at least has the following advantages:

In the driven electrode structure of an in-plane switching liquid crystal display in accordance with the present invention, each sub-driven electrode has a width decreasing in a longitudinal direction from the center to both sides of the sub-driven electrode, each sub-driven electrode has a width increasing in a longitudinal direction from the center to both sides of the sub-driven electrode, adjacent sub-driven electrodes have different widths or each sub-driven electrode is composed of two non-square structures connected to each other. By changing the width or the shape of each sub-driven electrode, at least two of the intervals in the sub-regions are different from one another. With this design, the Mura defect of the in-plane switching liquid, crystal display can be obscure, so as the Mura defect can be uniformly minimized without being visually recognized by human eyes and further improve the visual defect of the Mura.

While the invention has been described by means of specific embodiments, numerous modifications and variations could be made thereto by those skilled in the art without departing from the scope and spirit of the invention set forth in the claims.

What is claimed is:

1. A driven electrode structure of an in-plane switching liquid crystal display, the driven electrode structure is divided into a plurality of sub-regions, each of the sub-regions has a plurality of sub-driven electrodes, a plurality of intervals is formed between adjacent sub-driven electrodes, so as each of the sub-regions has the intervals, at least two of the intervals in the sub-region are different from one another.

2. The driven electrode structure of an in-plane switching liquid crystal display according to claim 1, wherein each sub-driven electrode has one of the widths decreasing in a longitudinal direction from the center to both sides of the sub-driven electrode, the intervals are different from one another, the difference between the intervals falls within a range of 0.2 μm˜20 μm, the sub-driven electrodes are disposed on the same layer or different layers.

3. The driven electrode structure of an in-plane switching liquid crystal display according to claim 2, wherein each of the sub-driven electrodes is a transparent electrode or a metal electrode.

4. The driven electrode structure of an in-plane switching liquid crystal display according to claim 2, wherein each of the sub-driven electrodes is made of a transparent conductive film or metal.

5. The driven electrode structure of an in-plane switching liquid crystal display according to claim 1, wherein each of the sub-driven electrodes has one of the widths increasing in a longitudinal direction from the center to both sides of the sub-driven electrode, the intervals are different, the difference between the intervals falls within a range of 0.2 μm˜-20 μm, sub-driven electrodes are disposed on the same layer or different layers.

6. The driven electrode structure of an in-plane switching liquid crystal display according to claim 5, wherein each of the sub-driven electrodes is a transparent electrode or a metal electrode.

7. The driven electrode structure of an in-plane switching liquid crystal display according to claim 5, wherein each sub-driven electrode is made of a transparent conductive film or metal.

8. The driven electrode structure of an in-plane switching liquid crystal display according to claim 1, wherein each of the adjacent sub-driven electrodes has a width different from one another, the intervals are different, the difference between the intervals falls within a range of 0.2 μm˜-20 μm, the sub-driven electrodes are disposed on the same layer or different layers.

9. The driven electrode structure of an in-plane switching liquid crystal display according to claim 1, wherein each of the sub-driven electrodes is composed of two non-square structures connected to each other.

10. The driven electrode structure of an in-plane switching liquid crystal display according to claim 9, wherein each of the non-square structure is a long elliptic structure, a circular arc structure or an irregular-shaped structure.
